(19) United States
(12) Patent Application Publication
(10) Pub. No.: US 2026/0170906 A1
(43) Pub. Date: Jun. 18, 2026

(54) Multi-Device and Tier Verification of Gaming Software License

(71) Applicant: Aristocrat Technologies, Inc., Las Vegas, NV (US)

(72) Inventors: Anthony Maffucci, Las Vegas, NV (US); Tyson Adams, Henderson, NV (US); William Harvie, JR., Murfreesboro, TN (US); Nimish Purohit, Las Vegas, NV (US)

(21) Appl. No.: 19/344,027

(22) Filed: Sep. 29, 2025

Related U.S. Application Data
(60) Provisional application No. 63/733,167, filed on Dec. 12, 2024.

(51) Int. Cl. G07F 17/32

(52) U.S. Cl. CPC G07F 17/3223; G07F 17/3227

(57) ABSTRACT

A system for providing multi-device and tier verification of gaming software licenses is described. A gaming device includes a game controller and a smart card having a license database for an electronic game. The gaming device includes a storage and a memory, each associated with license data. A verification process includes determining, based on the license database, whether the storage and memory have operated together previously. If the storage and memory have not operated together previously, a multi-tier license verification and update is performed. Upon completing license verification, the electronic game is playable on the gaming device.

### TECHNICAL FIELD

The field of disclosure relates generally to electronic gaming, and more particularly to systems and techniques for verifying validity of licenses for gaming software.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, a network architecture for an example system for facilitating license verification, in accordance with one or more embodiments.

FIG. 4 is a flowchart of a technique for performing license verification, in accordance with one or more embodiments.

FIG. 5 is a flowchart of a technique for responding to a license verification trigger, according to some embodiments.

FIG. 6 shows a flowchart of a technique for updating licensing data, according to some embodiments.

FIG. 7 shows a flowchart of a technique for using a counter value to gate operation of an electronic game, in accordance with one or more embodiments.

FIG. 8 shows a flowchart of a technique for using a system clock to update an iterative value, in accordance with one or more embodiments.

FIG. 9 shows a flowchart of a technique for adjusting the iterative value based on power cycle events, in accordance with one or more embodiments.

### DETAILED DESCRIPTION

Embodiments described herein are directed to a verification architecture that validates the game license information for a gaming machine. More specifically, embodiments described herein are directed to a verification module configured to perform a game license check within a gaming device. When the verification module determines that there is no license or incompatible licenses associated with some of the components, the verification architecture employes a three-tier system to update or reconfigure one or more components within the gaming device with the appropriate or compatible game license information.

The invention utilizes a verification module that is decoupled from the gaming device’s platform layer. The verification module, therefore, is external to the gaming device’s platform layer and utilizes APIs to perform inter-processing communication. In other words, the verification module is a standalone pre-process that executes at game start and/or based on a specific library call. The verification module checks three components in an EGM, the smart card, the game solid state device (SSD), and the SRAM memory device. The smart card is an internal memory device that acts as a broker that contains legacy database history that generally cannot be erased and/or destroyed. The SRAM is a memory device that is tied to the cabinet/hardware asset. The game SSD corresponds to the storage device that stores the game content (e.g., game files).

Techniques described herein provide a security mechanism through a novel verification process. Today’s gaming machines may not have a security mechanism to ensure games have not been counterfeited or copied without authorization. In other words, games can be cloned and placed into unauthorized gaming machines without the consent of the gaming manufacture. The embodiments described herein provide a solution to this problem using a unique architecture and process for confirming the validity of game license in order to gate functionality of the EGM.

The techniques described herein provide several technical improvements. For example, the technique can be widely implemented as it is platform agnostic. The tiered system allows for efficient license verification, even if network connections are unavailable or unreliable. Prior techniques fail to tie the license for the game to the hardware of the cabinet, whereas current techniques provide a technical solution to do so.

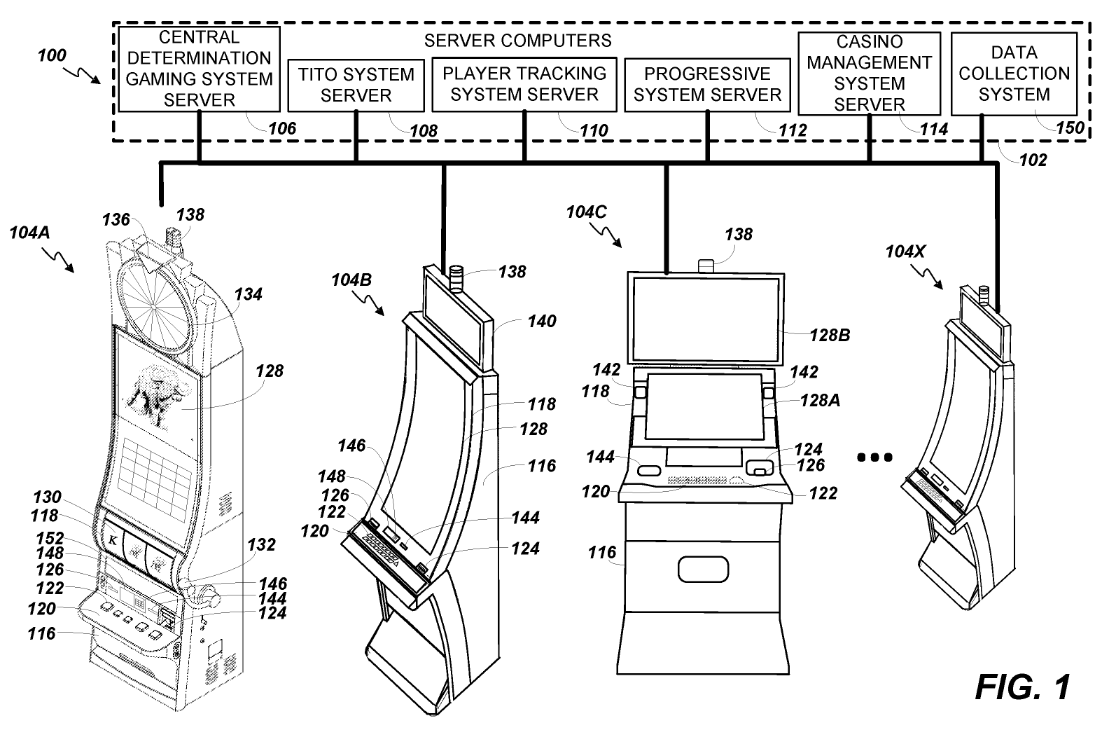

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards. Additionally, or alternatively, one or more of gaming devices 104A-104X may be configured as a tabletop game.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (Wi-Fi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, a casino management system server 114, and/or a data collection system 150. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL^{TM} model gaming device manufactured by Aristocrat^{®} Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player’s smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

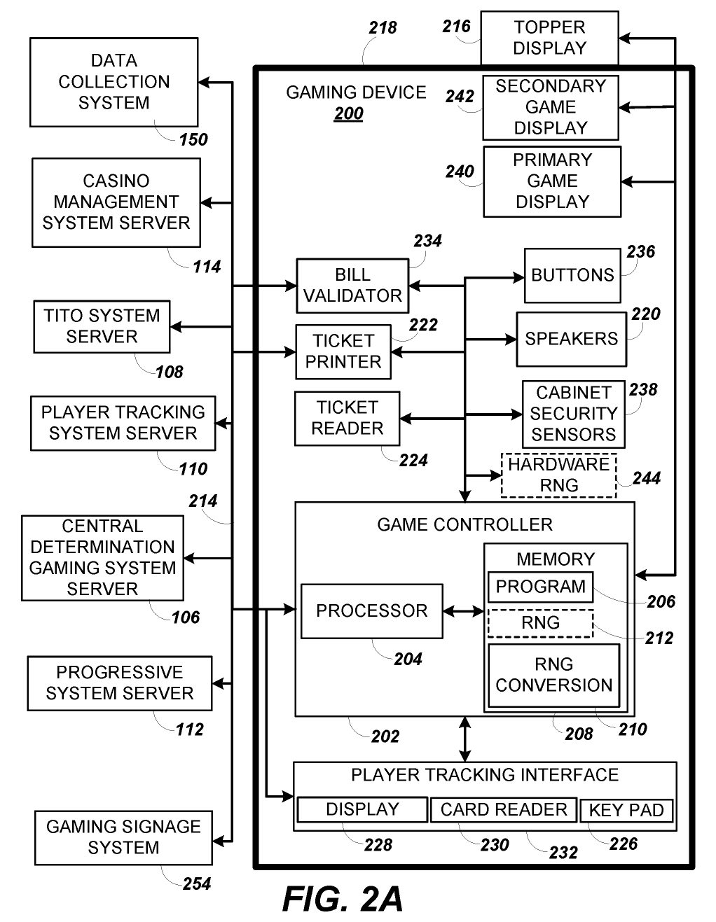

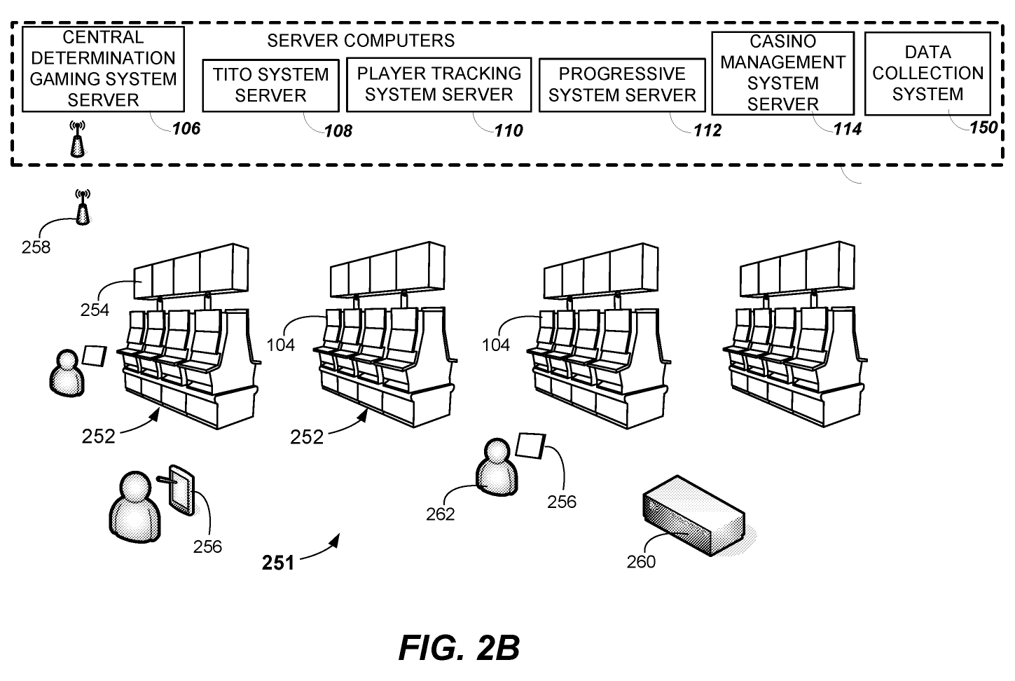

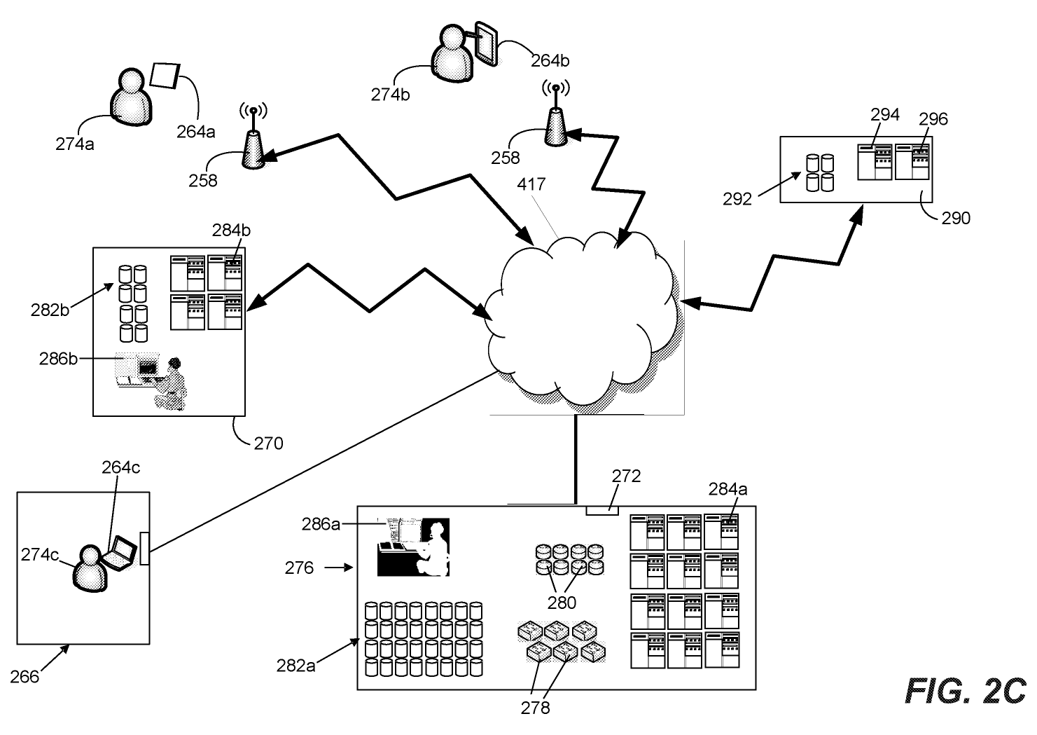

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc^{TM} model gaming device manufactured by Aristocrat^{®} Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix^{TM} model gaming device manufactured by Aristocrat^{®} Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Although gaming devices 104A-104X are shown in FIG. 1 as upright EGMs, the systems and methods described herein can be used on upright EGMs or table type EGMs.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

In an example embodiment, a tabletop EGM (not shown in FIG. 1) is provided which may be similar to the gaming devices 104. The tabletop EGM may include a horizontal display device that can be used by patrons as a conventional table surface as well as for providing player input (e.g., touchscreen surface, mechanical buttons, or the like) and display output (e.g., virtual wheel, virtual slot reels) for a tabletop game. The tabletop EGM may support participation for multiple players during game play (e.g., as patrons socially meet around the tabletop EGM). Example tabletop EGMs and features are described in greater detail below.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player’s credit value, a ticket reader 224 which reads bar-coded tickets or other media or mechanisms for storing or indicating a player’s credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random-access memory (DRAM), magnetic random-access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS^{®} system manufactured by Aristocrat^{®} Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron’s player loyalty card, a patron’s smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, computer code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player’s EUD. In other examples, code for executing at least some of the games may initially be stored on one or more of the servers 284a. Although only one gaming data center 276 is shown in FIG. 2C, some implementations may include multiple gaming data centers 276.

In some embodiments, a data collection system 290 is also configured for communication via the networks 417. Here, the data collection system 290 includes a collection server 294 and an authentication server 296. According to some embodiments the collection server is configured to store the collected data for later use, such as data analytics and the like. In some embodiments, the collection server 294 may be configured to facilitate storage of collected data in an additional network storage 292. The data collection system 290 also includes an authentication server 296, which provides authentication services for devices collecting data. In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a–274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player’s “cash in” selections, wagering game results and a player’s “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a–274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

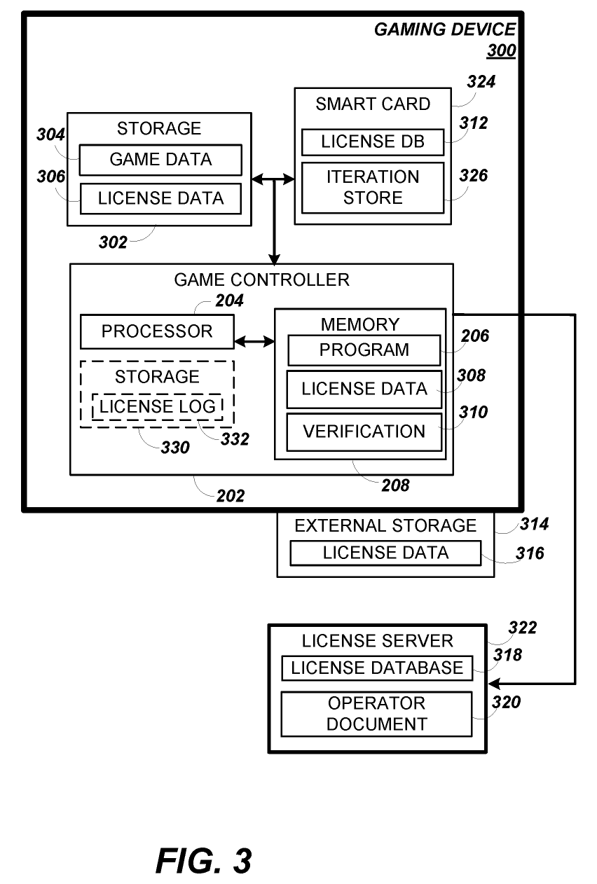

FIG. 3 is a block diagram of a gaming device 300, according to one or more embodiments. The gaming device 300 includes a game controller 202, configured to provide functionality for electronic games on the gaming device 300. The gaming device 300 may also include a smart card 324, which may be any type of storage device external to the game controller 202. The smart card 324 may be a storage device that stores data and can be read by a card reader. According to some embodiments, the smart card 324 is configured to store a license database 312. To that end, the smart card may act as a broker that contains legacy database history that, in some embodiments, cannot be erased or destroyed. The license database may include information such as a history information that indicates whether components of the game controller have previously run together. In some embodiments, the smart card 324 may include iteration store 326, which is configured to store an iterative value. In some embodiments, the game data 304 may be configured to perform a validation check prior to allowing operation of the game, for example by comparing an iterative value form iteration store 326 to a launch criterion. In some embodiments, the iterative value maybe initially set based on the license data 306. For example, the computer code for a particular game may be configures to make a call to the smart card 324 to obtain the iterative value from iteration store 326. If the value fails to satisfy a launch threshold, it may be determined that operation of the game should be blocked. In some embodiments, the iteration store 326 may receive updated iterative values, for example from game controller 202. The updated values may increment or decrement the values periodically, for example based on a system clock value. In some embodiments, the iterative value may further be adjusted based on system settings, such as to compensate for power cycles, or for other factors which may cause the length of time the game is operable to be adjusted.

The game controller 202 may include various components, such as a processor 204, which is configured to execute computer readable code, such as computer programming modules in memory 208. The computer programing models in memory 208 may include a gaming program 206. In addition, memory 208 may also store a license data module 308 and a verification module 310. The license data module 308 may include a primary key and/or a derived key for a license. The verification module may be configured to perform a check on components within the gaming device to determine whether a game is licensed for the device. In some embodiments, the verification process can be performed when the gaming machine is initially deployed to a gaming site such as a casino. The verification process can also occur when a game controller memory 208 has been cleared, such as when a new game is added to the gaming device 300. In yet another example, the verification module can perform a license check when the gaming machine is powered off and on, or on a periodic schedule.

In some embodiments, game controller 202 also includes an optional storage 330. Storage 330 may be a nonvolatile memory. Examples of storage 330 include read-only memory (ROM), hard disk drives, solid-state drives, universal serial bus (USB) flash drives, or the like. Examples of ROM include a programmable read-only memory (PROM), an erasable programmable read-only memory (EPROM), an electrically erasable programmable read-only memory (EEPROM), or other like memory device. According to one or more embodiments, the storage 330 in the game controller 202 may be configured to store license log 332. The license log 332 may be configured to store data related to the successful deployment of a new game. For example, the license log may capture license information, hardware information (such as hardware identifiers for the storage 302, smart card 324, or the like), time stamps or other contextual data indicative of circumstances around which the license was verified for initial deployment of a game.

According to some embodiments, gaming device 300 also includes storage 302. Storage 302 may include a solid state drive (SSD) or other non-volatile storage device, and may be external to the game controller 202. In some embodiments, storage 302 is configured to store game data 304, which may be used to execute the gaming program 206. Storage 302 may also be configured to store license data 306. License data 306 may include a primary key and/or a derived key for a license.

In some embodiments, gaming device 300 may be configured to read from external storage 314, such as through a USB connection or other means. External storage 314 may include license data 316. In some embodiments, an operator can use the external storage 314 to update license information on the components on gaming device 300.

Gaming device 300 may also communicate with a license server 322. License server 322 may include license information for the game, such as a license database 318, and an operator document 320. The gaming device 300 may connect to the license server, for example across a wide area network. License server 322 may provide up to date information about the license for the game.

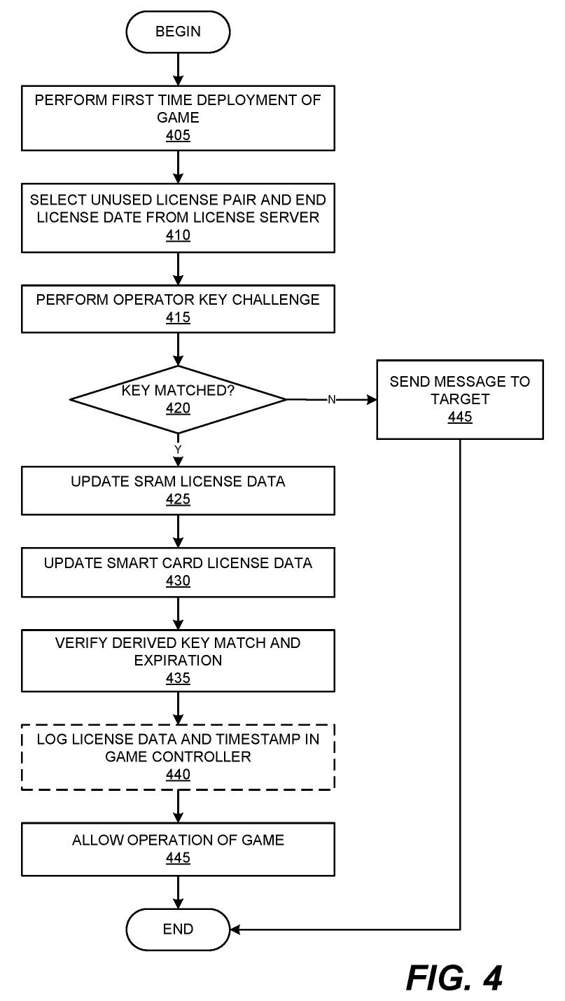

FIG. 4 is a flow diagram of a process for performing an initial deployment of a game on a gaming device, according to one or more embodiments. The process may start at block 405, where the game controller may perform an initial deployment of a game on the gaming device 200. The initial deployment may occur when the gaming device 200 is initially installed at a casino site, or when a new game is added to the gaming device 200.

At block 410, an unused license key pair and an end license date for the game may be selected from the license server 322. The license pair may include a primary key and a secondary key that are unique and associated with the game. The end license date may indicate the expiration date of the game license.

At block 415, the game controller 202 may perform an operator key challenge. The operator key challenge may involve presenting a primary key for the game, and prompting an operator to provide a secondary key. The operator may obtain the secondary key from an operator document that is provided by the gaming manufacturer. The operator document may include a list of license pairs for the games that the operator has purchased, and may be a security measure to prevent unauthorized access or use of the game license. Accordingly, the license pairs may be assigned to a particular entity.

At block 420, the game controller 202 may determine whether the key entered by the operator matches the secondary key of the license pair. If the key matches, the process concludes at block 445, and one or more messages are sent regarding the failed verification. For example, a message may be presented to or transmitted to an operator or other party.

Returning to block 420, if the key match is verified, then the flowchart proceeds to block 425. At block 425, the game controller may update the SRAM license data with the license pair and the end license date. The SRAM license data may include the primary key, a derived key, and the end license date, or some combination thereof. The derived key may be generated by applying a mathematical operation, such as an exclusive OR (XOR), to the primary key and the secondary key. The SRAM license data may be encrypted and stored in the SRAM memory device.

At block 430, the game controller may update the verification smart card license data with the license pair and the end license date. The verification smart card license data may include the primary key, the derived key, the end license date, and history information. The history information may indicate whether various components have previously run together.

At block 435, the game controller may verify the derived key match and the expiration date. The game controller may compare the derived key stored in the SRAM with the derived key stored in the smart card and/or the game SSD. The game controller may also compare the current date with the end license date stored in the SRAM, the verification smart card 324, and/or the game SSD. The game controller may determine whether the derived keys match and whether the end license date has not expired.

The flowchart proceeds to optional block 440, where license data and a timestamp are logged by storage 330, for example in license log 332. The log may include identifiers for the software and/or hardware involved in the license verification process, as well as license information. Further, contextual information such as time stamp, location information, site information, or the like may also be stored in the license log. The license log may therefore act as a historic log of how the game controller has been used. In some embodiments, at least some of the data stored in the license log may be received from the game SSD.

At block 445, if the game controller 202 determines that the derived keys match and the end license date has not expired, the game controller may permit the operation of the game on the gaming device. Alternatively, at block 445, if the game controller determines that the derived keys do not match or the end license date has expired, or if the operator key challenge fails, an error code or message can be provided.

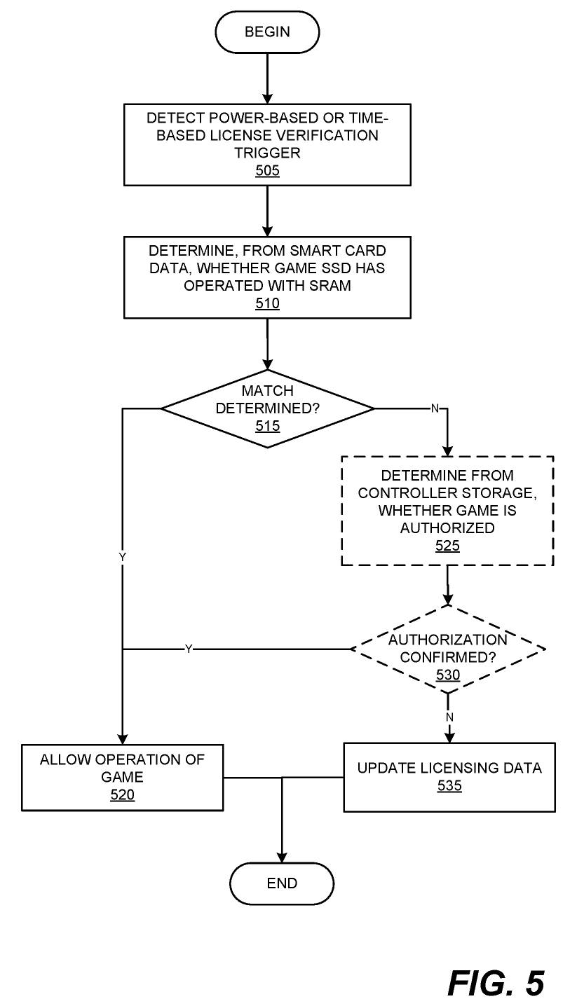

FIG. 5 is a flow diagram of a process for performing a power-based or time-based license verification according to one embodiment. Generally, license verification involves performing a check on three components of an electronic gaming machine, including a game controller memory, a first game device storage, and a second game device storage such as a smart card. According to some embodiments, the memory device is tied to the game cabinet or hardware. The first storage may include game content, such as game files. The second storage or smart card may act as a broker that contains legacy database history, such as history information that indicates whether the first storage and the memory device have previously run together.

The process may start at block 505, where the game controller may detect a power-based or time-based license verification trigger. The power-based trigger may occur when the gaming device is powered OFF and ON, such as during a system power cycle, or based on a power cycle mode. The time-based trigger may occur when a predetermined time interval has elapsed, such as weekly or monthly, relating to license renewals. Other instances which may trigger a game license check include when the game machine is initially deployed to a site, such as a casino, or when a new game is added to the gaming machine.

At block 510, the game controller may determine, from the smart card data, whether the game SSD has previously operated with the SRAM. The game controller may read the history information stored in the memory of the verification smart card, and compare it with the game SSD identifier and the SRAM identifier. The game controller may determine whether the verification smart card has been previously associated with the game SSD and the SRAM.

At block 515, the game controller 202 may determine whether a match is determined based on the verification smart card data. A match may be determined, for example, if the SSD and SRAM have previously operated together. If a match is determined, the process may proceed to block 520, and the game is allowed to operate on the gaming device.

Returning to block 515, if a match is not determined, then the flowchart optionally proceeds to block 525. At optional block 525, a determination is made as to whether the game is authorized. This may involve analyzing data from the license log in storage on the game controller to determine whether the game is authorized for the hardware. The match may not be determined for example, if the SRAM of the game controller has been cleared, or the SRAM has otherwise lost the data. Thus, a storage on the game controller may be used as a secondary check. For example, a determination may be made as to whether the SSD has ever operated with the game controller based on data in the license log. The flowchart proceeds to optional block 530 and, if authorization is confirmed, then the process proceeds to block 520, and the game is allowed to operate on the gaming device.

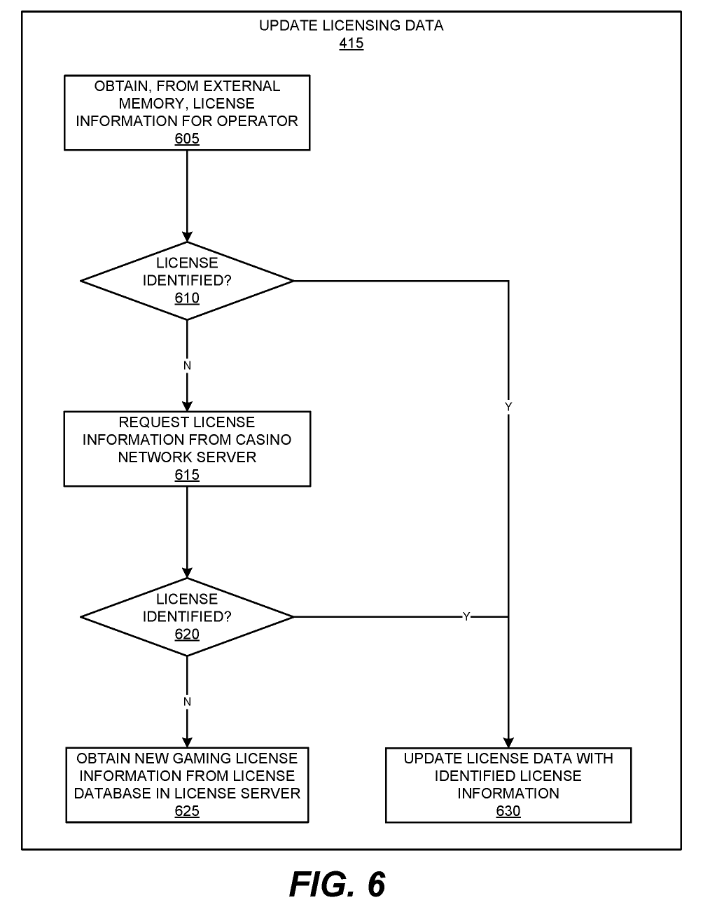

Alternatively, if at block530, authorization is not confirmed, or if optional blocks are skipped and at block 515 a match is not determined, the process may conclude at block 535, and licensing data may be updated, as will be described in greater detail below with respect to FIG. 6.

FIG. 6 is a flow diagram of a process for updating licensing data according to one embodiment. The process may be performed, for example, when it is undetermined whether the game SSD has operated with the SRAM.

The process begins at block 605 where license information for the operator is obtained for external memory. In some embodiments, the external memory may be a USB key or other memory accessible at the gaming device. Alternatively, the external memory may be a server at the casino or gaming environment, or may be a remote networking device. In some embodiments, the external memory used may be determined based on a multitier process. For example, as a first tier, a first memory accessible by USB or other local connection can be used to obtain license information. At block 610, the game controller 202 may determine whether a license is identified for the game SSD from the external memory.

If a license is not identified, then the flowchart proceeds to block 615. at block 615, the game controller may request license information from a casino network server as part of a second tier. The casino network server may include a local casino network server that is connected to the gaming device via a local area network. The local casino network server may include license information for one or more of the games that the operator has purchased from the gaming manufacturer. The license information may include license pairs and end license dates for the games.

At block 620, the game controller 202 may determine whether a license is identified from the casino network server. If a license is not identified, the process may proceed to block 625. At block 625, the game controller may obtain new gaming license information from a license database in the license server as a third tier. The license server may include a remote server that is connected to the gaming device via a wide area network or the Internet. The license server may include a license database that stores license information for all of the games that the gaming manufacturer has produced. The license information may include license pairs and end license dates for the games. Alternatively, the game controller 202 may obtain the new gaming license information by calling a support agent and/or using a mobile application, and providing a responding/challenge key to receive the new gaming license information.

Returning to blocks 610 and 620, if a determination is made that a license is identified, then the flowchart concludes at block 630. At block 630, the game controller may update the license data with the identified or new license information. The game controller may also update the history information stored in the verification smart card to reflect the new association with the game SSD and the SRAM.

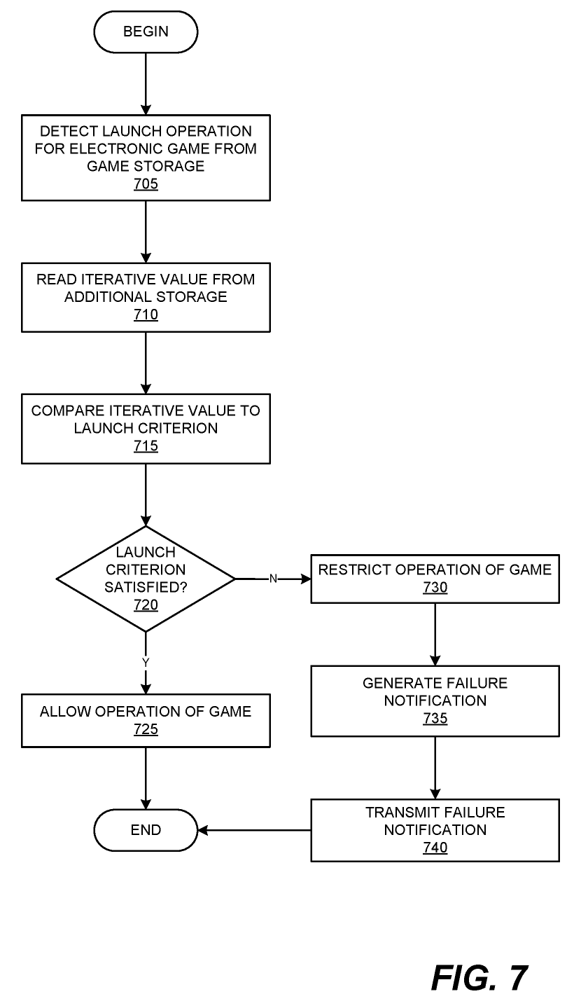

According to some embodiments, an iterative value stored on the smart card 324 may be used to gate operation of an electronic game on the gaming device. For example, gaming data may include computer code which, when executed by processor to a floor, may perform a validation check, which may include comparing an iterative value from iteration store 326 to a launch criterion. FIG. 7 shows a flowchart of a technique for using a counter value to gate operation of an electronic game, in accordance with one or more embodiments.

The flowchart begins at block 705 where an electronic game from game storage is launched. In some embodiments, the game controller 202 detects a launch operation for an electronic game whose computer readable code resides on storage 302. In one implementation, processor 204, executing code in memory 208, recognizes a platform-level request to initiate the game and invokes a license/launch check prior to allowing execution of the electronic game from storage 302.

At block 710, the system reads an iterative value from an additional storage, separate from the game storage. According to one or more embodiments, instructions from within the electronic game may cause the game controller 202 to call the iteration value from an iteration store on a license storage such as smart card 324. In some embodiments, the iterative value may be stored on a secure storage device, which may also store licensing data, and which may be external to the game controller.

The flowchart proceeds to block 715, where the iterative value from the external storage is compared with a launch criterion. In some embodiments, the launch criterion may require the iteration value to exceed a threshold, such as a policy-dependent minimum value that is derived from license data for the game. If the iteration value satisfies the launch criterion, then the flowchart concludes at block 725, and the game controller can allow operation of the game.

Returning to block 720, if the launch criterion is not satisfied, then the flowchart proceeds to block 730. At block 730, the game controller 202 restricts, or gates, operation of the game by preventing launch the game itself. In some embodiments, because the instructions to compare the iterative value to a launch criterion may be processed from the electronic game computer code, restricting the operation of the game may include reducing or blocking one or more features of the game from executing.

Th flowchart proceeds to block 735, where a failure notification is generated. In some embodiments, the failure notification may be a visual or on-device message may be presented regarding the failed launch criterion. In some embodiments, the failure notification may include contextual information which may be gathered with respect to the game, the cabinet, and the like.

The flowchart then concludes at block 740, where the failure notification is transmitted. In some embodiments, transmission may include presenting the notification on the local device. As another example, the notification may be transmitted to a content management system, a license server, an operator system, or the like.

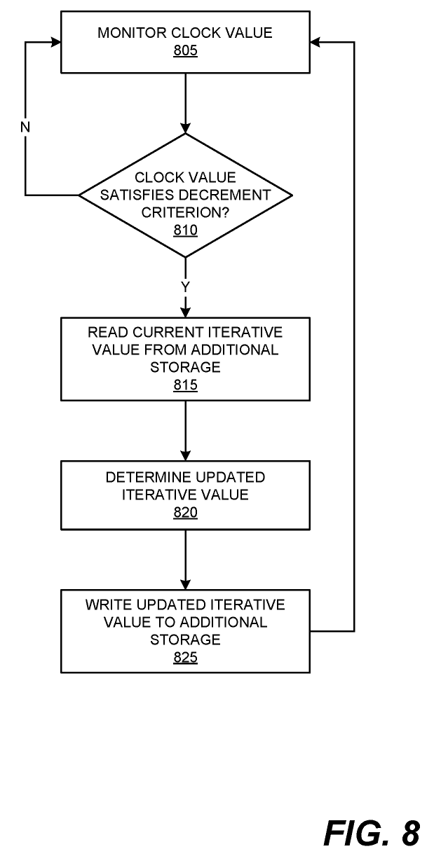

According to some embodiments, the iterative value may be incremented or decremented periodically. FIG. 8 shows a flowchart of a technique for using a system clock to update an iterative value, in accordance with one or more embodiments.

The flowchart begins at block 805, where the game controller 202 monitors a clock value. The monitored clock may be a system clock or timer accessible to the game controller 202. At block 810, the game controller 202 determines whether the current clock value satisfies a decrement criterion. For example, the decrement criterion may define a periodic interval (e.g., approximately every 10–30 seconds, every minute, every hour, etc.) at which the iteration value is to be decremented (or, in some instances, incremented) while the electronic game is operating. In some embodiments, the iterative value may be decremented whether or not the game is operating. If a determination is made that the clock value does not satisfy the decrement criterion, then the flowchart returns to block 805, and the game controller 202 continues to monitor the clock value

Returning to block 810, if a determination is made that the clock value satisfies a decrement criterion, then the flowchart proceeds to block 815. At block 815 the game controller 202 reads a current iterative value from the additional storage, such as smart card 324. In some embodiments, the additional storage stores license data, for example in a license database, which may be associated with one or more electronic games. At block 820, the game controller 202 determines an updated iterative value, for example by incrementing or decrementing the current iterative value as configured by the launch criterion.

The flowchart concludes at block 825, where the game controller 202 writes the updated iterative value back to the additional storage. This periodic write maintains the current state of the iterative value on the external storage, such as a secure storage device. The flowchart then returns to block 805, and the game controller 202 continues to monitor the clock value for the next satisfied interval.

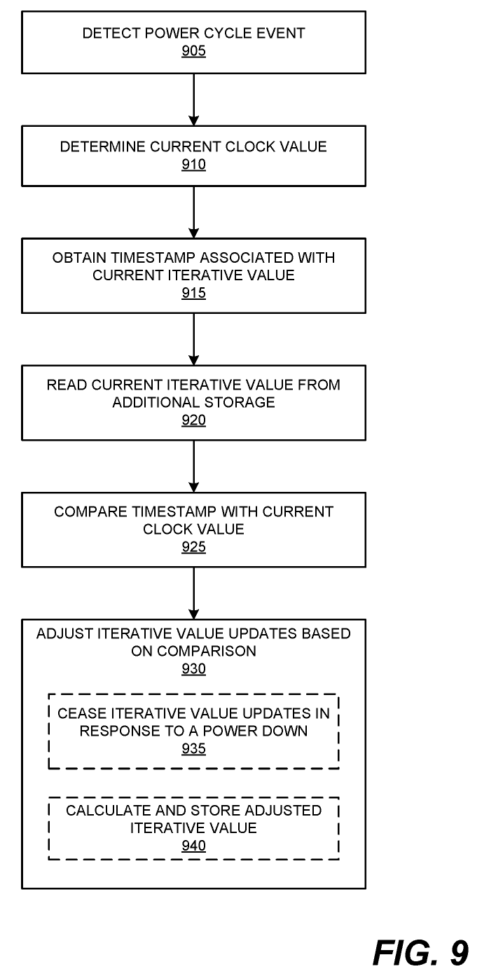

Embodiments described herein support various configurations for managing the iterative value with respect to operation of a game and/or gaming device. FIG. 9 shows a flowchart of a technique for adjusting the iterative value based on power cycle events, in accordance with one or more embodiments.

The flowchart begins at block 905, where a power cycle event is detected, such as the restoration of power to the gaming device after a shutdown. Upon detecting this event, the flowchart proceeds to block 910, and the game controller 202 determines the current clock value, which may be obtained from a system clock or real-time clock accessible to the controller.

The flowchart proceeds to block 915, where the game controller 202 obtains a timestamp associated with the current iterative value. This timestamp may have been previously written to the smart card 324 or another storage device (such as storage 330) during the last periodic update of the iteration value, as described in connection with FIG. 8. The timestamp represents the last known time at which the iteration value was decremented and stored.

At block 920, the game controller 202 reads the current iterative value from the additional storage, for example the smart card 324 or other secure and/or external storage. The iterative value represents the remaining authorized operation cycles for the electronic game. In some embodiments, the iterative value may be used to enforce license terms. For example, the iterative value may indicate a number of iterations that correspond to an expiration of a license for the game on the gaming device. The flowchart proceeds to block 925, where the controller compares the stored timestamp with the current clock value. This comparison allows the controller to determine the duration for which the gaming device was powered down or otherwise not adjusting the iteration value (for example, decrementing or incrementing the value in accordance with a configuration of the launch criterion).

The flowchart concludes at block 930, where the game controller 202 adjusts the iterative value based on the comparison between the stored timestamp and the current clock value. In some embodiments, the device may compensate for elapsed time during the power-down period. This may occur, for example, if the license indicates a valid license term that is based on operational time, such as when the device is powered on, as shown at optional block 935. To that end, an adjustment may include a verification that the iterative value remains static after detecting initiation of a power down event. Alternatively, the license terms may indicate a valid license term based on real-world time, regardless of power state of the device. To that end, as shown at block 940, the controller calculates and stores the adjusted iterative value back to the smart card 324. For example, the controller may decrement the iterative value by an amount corresponding to the elapsed time. The controller may then write the decremented value to the additional storage.

While the invention has been described with respect to the figures, it will be appreciated that many modifications and changes may be made by those skilled in the art without departing from the spirit of the invention. Any variation and derivation from the above description and figures are included in the scope of the present invention as defined by the claims.

What is claimed is:

1. A system comprising:
a first storage device comprising a license database and first license data;
a second storage device comprising gaming data and second license data; and
a game controller, comprising:
a processor, and
a memory associated with third license data, and comprising computer readable code executable by the processor to:
determine, based on the license database from the first storage device, whether the second storage device has previously operated with the memory, wherein the first storage device and the game controller are comprised in a gaming device;
in accordance with a determination that the second storage device has not previously operated with the memory, perform a license update process; and
in accordance with a determination that the second storage device has previously operated with the memory, permit operation of a game associated with a license in the license database.

2. The system of claim 1, wherein the license update process comprises:
requesting updated license data from one or more external storage devices; and
in response to receiving updated license data, update the license database based on the updated license data.

3. The system of claim 2, wherein at least one of the one or more external storage device is physically coupled to the gaming device, and wherein the at least one of the one or more external storage devices comprises a plurality of licenses assigned to a particular entity.

4. The system of claim 2, wherein the license update process further comprises:
in response to a detected failure to obtain the updated license data from the one or more external storage devices, request the updated license data from a local server, wherein the local server and the gaming device are communicably connected across a local area network.

5. The system of claim 1, wherein the license update process further comprises:
in response to a detected failure to obtain the updated license data from the local server, request the updated license data from a remote server, wherein the remote server and the gaming device are communicably connected across a wide area network.

6. The system of claim 5, further comprising computer readable code to:
in response to receiving the updated license data, update the license database based on the updated license data.

7. The system of claim 2, further comprising computer readable code to:
in accordance with the license update process, perform license verification, and
in accordance with the license verification, permit operation of a game.

8. A non-transitory computer readable medium comprising computer readable code executable by one or more processor to:
determine, based on a license database in a storage external to a game controller, whether a game device storage device has previously operated with a game controller memory, wherein the storage and the game controller are comprised in a gaming device;
in accordance with a determination that the game device storage device has not previously operated with the game controller memory, perform a license update process; and
in accordance with a determination that the game device storage device has previously operated with the game controller memory, permit operation of a game associated with a license in the license database.

9. The non-transitory computer readable medium of claim 8, wherein the license update process comprises:
requesting updated license data from one or more external storage devices; and
in response to receiving updated license data, update the license database based on the updated license data.

10. The non-transitory computer readable medium of claim 9, wherein at least one of the one or more external storage device is physically coupled to the gaming device, and wherein the at least one of the one or more external storage devices comprises a plurality of licenses assigned to a particular entity.

11. The non-transitory computer readable medium of claim 9, wherein the license update process further comprises:
in response to a detected failure to obtain the updated license data from the one or more external storage devices,
request the updated license data from a local server, wherein the local server and the gaming device are communicably connected across a local area network.

12. The non-transitory computer readable medium of claim 11, wherein the external storage device is coupled to the license update process further comprises:
in response to a detected failure to obtain the updated license data from the local server,
request the updated license data from a remote server, wherein the remote server and the gaming device are communicably connected across a wide area network.

13. The non-transitory computer readable medium of claim 12, further comprising computer readable code to:
in response to receiving the updated license data, update the license database based on the updated license data.

14. The non-transitory computer readable medium of claim 8, further comprising computer readable code to:
in accordance with the license update process, perform license verification, and
in accordance with the license verification, permit operation of a game.

15. A method comprising:
performing, on a gaming device, initial deployment of a game on a gaming device;
obtaining an unused license key pair from a license server;
updating local license data in a game controller memory based on the unused license key pair and the gaming device;
causing a remote license database on the license server to be updated based on the unused license key pair and the gaming device; and
enabling operation of the game on the gaming device.

16. The method of claim 15, wherein the license key pair comprises a primary key and a secondary key.

17. The method of claim 16, wherein updating local license data further comprises:
generating a derived key from the primary key and secondary key; and
storing the primary key and the derived key in the game controller memory.

18. The method of claim 17, further comprising:
storing the derived key in a storage, wherein the storage is separate from a gaming engine in the gaming device.

19. The method of claim 18, further comprising, in response to a license verification trigger:
determining whether the derived key in the game controller memory matches the derived key in the storage.

20. The method of claim 19, wherein the storage comprises a smart card.
